(19) United States
(12) Patent Application Publication
(10) Pub. No.: US 2026/0016032 A1
(43) Pub. Date: Jan. 15, 2026

(54) CONNECTING ELEMENT FOR MECHANICALLY COUPLING COMPONENTS

(71) Applicant: Thor Tech, Inc., Elkhart, IN (US)

(72) Inventors: Michael Schroll, Kisslegg (DE); Christian Borgenheimer, Warthausen (DE)

(73) Assignee: Thor Tech, Inc., Elkhart, IN (US)

(21) Appl. No.: 19/259,353

(22) Filed: Jul. 3, 2025

(30) Foreign Application Priority Data
Jul. 9, 2024 (DE) 10 2024 119 468.5

(51) Int. Cl. F16B 5/06

(52) U.S. Cl. CPC F16B 5/0607; F16B 2005/0678

(57) ABSTRACT

The invention relates to a connecting element for mechanically coupling components. The connecting element comprising a first tab configured to mechanically couple a rear outer surface of a first component to the connecting element and a second tab is configured to mechanically couple a rear outer surface of a second component to the connecting element. The coupling element is mechanically coupled to the first tab and the second tab, and the first component and the second component each have an edge-side projection. The coupling element is configured to mechanically couple the first edge-side projection of the first component and the second edge-side projection of the second component to the coupling element such that an end face of the first edge-side projection and an end face of the second edge-side projection are arranged adjacent to one another on a front-side outer surface of the edge-side projections.

### CROSS-REFERENCE TO RELATED APPLICATIONS

This application claims priority to German application No. 10 2024 119 468.5 filed Jul. 9, 2024, the disclosure of which is hereby incorporated by reference in its entirety.

### FIELD

The present invention relates to a connecting element for mechanically coupling components, to a connecting system for mechanically coupling components and to a use of a connecting element for coupling layered composite panels.

### BACKGROUND

Vehicles with living space, such as mobile homes or caravans, regularly use lightweight panels for their interiors. These panel elements are used, for example, for furniture parts or as trim panels and can be provided with different decorations. Panel elements or layered composite panels that have a sandwich structure with a core material between two outer top layers have proven to be particularly advantageous. Due to their sandwich structure, such layered composite panels can have a lightweight core material arranged between the two top layers and can provide high stability with a low surface weight. The respective top layers can allow for different decorations. In order for such layered composite panels to be laterally joined in an appealing manner for installation in a vehicle, in particular in the living space of a vehicle, a connecting element is to be provided which can replace typical separation profiles and can arrange two such layered composite panels as closely as possible to one another, taking into account the sandwich structure.

### SUMMARY

The present invention achieves the object according to the independent claims with a connecting element for mechanically coupling components, a connecting system for mechanically coupling components and a use of a connecting element for coupling layered composite panels. Further embodiments can be found in the description, the dependent claims and the figures.

According to a first aspect of the present invention, a connecting element for mechanically coupling components is proposed. The connecting element has a first tab, a second tab and a coupling element. The first tab is configured to mechanically couple a rear outer surface of a first component to the connecting element. Furthermore, the second tab is configured to mechanically couple a rear outer surface of a second component to the connecting element. The coupling element is mechanically coupled to the first tab and the second tab. The first component and the second component each have an edge-side projection. The coupling element is configured to mechanically couple the first edge-side projection of the first component and the second edge-side projection of the second component to the coupling element such that an end face of the first edge-side projection and an end face of the second edge-side projection are arranged adjacent to one another on a front-side outer surface of the edge-side projections.

The components can be in particular coupled to one another by the connecting element such that a front-side outer surface of the particular projection of the particular component continues a front-side outer surface of the particular component. In other words, the connecting element can be configured to arrange the front-side outer surface of the first component in alignment with the front-side outer surface of the second component, in particular adjacent to one another.

The edge-side projection of the particular component can be arranged on an outer edge of the component. The edge-side projection can be a projection of the particular component which is arranged on an outer edge of the component. The face side of the edge-side projection can define a surface that defines an edge of the edge-side projection. The face side of the edge-side projection of the particular component can be provided and/or configured to be arranged, in particular directly, on a face side of an edge-side projection of another component by means of the connecting element.

The coupling element can be in particular configured to mechanically couple the first edge-side projection of the first component and the second edge-side projection of the second component to the coupling element such that the end face of the first edge-side projection and the end face of the second edge-side projection are arranged adjacent to one another on a front-side outer surface of the components, in particular directly, and that advantageously the front-side outer surfaces of the components and the front-side outer surfaces of the edge-side projections are aligned flush with one another. An outer surface of the projection can continue an outer surface of the particular component.

The first component and/or the second component can be designed to be flat, in particular corresponding to a panel.

Advantageously, by means of the connecting element, the front-side outer surface of the first edge-side projection and of the second edge-side projection can be arranged linearly adjacent to one another, and in particular come into direct contact at points of the joined edge-side projections.

The particular end face of the edge-side projections can be inclined at right angles to the front-side outer surface or at an angle to the front-side outer surface of the edge-side projections.

The connecting element can have the shape of an elongated profile strip along the end faces of the edge-side projections and can be in particular arranged between the components behind the edge-side projections such that it cannot be seen from a front side. This advantageously allows for an appealing coupling of the components.

For example, at least one of the components can comprise a layered composite material in which thin outer top layers comprise a light intermediate layer, wherein the intermediate layer can, for example, have a honeycomb structure.

According to one aspect, it is proposed for the coupling element to have a contact surface. The coupling element is furthermore configured to mechanically couple an inwardly directed surface of the first edge-side projection of the first component and an inwardly directed surface of the second lateral projection of the second component to the contact surface of the coupling element by means of the contact surface in order to arrange the end face of the first edge-side projection and the end face of the second edge-side projection adjacent to one another. In this case, the inwardly directed surface of the particular lateral projection can define a surface of the particular lateral projection which is spaced from the outer surface and the surface normal of which is oriented substantially opposite to the surface normal of the outer surface of the component, in particular if the lateral projection has an outer top surface, which is in particular part of the outer surface of the component, and an inwardly directed surface.

In particular, at least part of the contact surface of the coupling element can be mechanically coupled to the inwardly directed surfaces of the particular edge-side projections by means of surface bonding. Advantageously, surface bonding can be carried out using a liquid adhesive and/or an adhesive tape.

In particular, the coupling element can be configured to be arranged at least predominantly between the first component and the second component. Alternatively or additionally, the coupling element can be configured to be mechanically coupled to a side surface of the first component by means of a first side surface of the coupling element. Alternatively or additionally, the coupling element can be configured to be mechanically coupled to a side surface of the second component by means of a second side surface of the coupling element. The side surface of the particular component can define a surface at an edge of the component, whereby the edge-side projection of the particular component protrudes beyond the side surfaces at the edge of the particular component. The first edge-side projection and/or the second edge-side projection can be manufactured, for example, by milling a shoulder on an edge of the first component and/or an edge of the second component.

Advantageously, the first component and/or the second component can each comprise a layered composite panel and/or be manufactured based on a layered composite panel. The first edge-side projection and/or the second edge-side projection can be formed substantially by a corresponding top layer of the particular layered composite panel.

According to one aspect, it is proposed for the connecting element to be formed in two parts and for the coupling element to have a first sub-element with the first tab and a second sub-element with the second tab. When the sub-elements are brought together and/or pivoted, the first sub-element and the second sub-element can be designed to interact such that the end position of pivoting is defined by the end face of the first edge-side projection and the end face of the second edge-side projection abutting against one another.

Thus, the first sub-element of the coupling element can form a first part of the connecting element with the coupled first tab and the second sub-element of the coupling element can form a second part of the connecting element with the coupled second tab.

The two-part connecting element can also be used for mechanically coupling components. The two-part connecting element has a first tab, a second tab and a coupling element. The first tab is configured to mechanically couple a rear outer surface of a first component to the connecting element. Furthermore the second tab is configured to mechanically couple a rear outer surface of a second component to the two-part connecting element.

The one-part connecting element or the two-part connecting element can be used throughout furniture and vehicle construction.

The first sub-element can be mechanically coupled to the first tab and the second sub-element can be mechanically coupled to the second tab. The first component and the second component each have an edge-side projection. The first sub-element can be configured to couple the first edge-side projection of the first component to the first sub-element. The second sub-element can be configured to mechanically couple the second edge-side projection of the second component to the second sub-element. In this case, the first sub-element can interact with the second sub-element such that an end face of the first edge-side projection and an end face of the second edge-side projection are arranged adjacent to one another on a front-side outer surface of the edge-side projections.

By means of the one-part or two-part connecting element, the components, such as layered composite panels, can be joined with the particular edge-side projections practically without joints, so that substantially a zero joint is formed in particular between the two components. The components can be arranged adjacent to one another with almost no gaps or overhangs.

The first sub-element can have a first contact surface and be configured to couple an inwardly directed surface of the first edge-side projection of the first component by means of the first contact surface. The second sub-element can have a second contact surface and be configured to mechanically couple an inwardly directed surface of the second lateral projection of the second component to the second contact surface of the second sub-element in order to arrange the end face of the first edge-side projection and the end face of the second edge-side projection adjacent to one another.

The first sub-element and the second sub-element can form a connecting element by means of pivoting, which can be arranged at least predominantly between the first component and the second component. Alternatively or additionally, the first sub-element can be configured to be mechanically coupled to a side surface of the first component by means of a first side surface of the first sub-element. Alternatively or additionally, the second sub-element can be configured to be mechanically coupled to a side surface of the second component by means of a second side surface of the second sub-element.

Advantageously, the first component and/or the second component, which can be coupled to the two-part connecting element, can comprise a layered composite panel. The first edge-side projection and/or the second edge-side projection can be formed substantially by a corresponding top layer of the particular layered composite panel.

According to one aspect, the first sub-element can have a tongue curved in a cross section and the second sub-element can have a recess curved in a cross section. The two sub-elements can be designed such that by pivoting the first sub-element relative to the second sub-element in an end position of pivoting, a mutual positive connection of the respective sub-elements of the coupling element is formed, in particular in order to connect or couple the two sub-elements to one another.

In other words, a first sub-element in the form of a profile strip and a second sub-element in the form of a further profile strip can be positioned in recesses of the components, which are formed by the edge-side projections, adjacent to an edge of the components and can be connected to the particular components by means of connecting technology. By means of a pivoting or rotating movement, which is predetermined by the shape of the curved tongue of the first sub-element and the shape of the curved recess of the second sub-element, the pivoting can be guided, and the components, the cavities or recesses of which have been previously filled with adhesive and sealant, can be joined to substantially form a zero joint. In addition, pivoting of the sub-elements results in a positive connection of the sub-elements and thus a coupling of the components.

In particular, the shape of the curved tongue and/or the curved recess can be configured to effect a mutual positive locking of the respective sub-elements in a direction parallel to the front-side outer surface of the components. For this purpose, the curved tongue can form a concave, in particular circular cylinder segment-shaped, engagement surface on a top surface of the tongue. In addition, the curved recess can form a convex, in particular circular cylinder segment-shaped, engagement surface on a top surface of the recess for the mutual positive locking, wherein the engagement surface can be arranged adjacent to one another in the end position of pivoting in order to effect the mutual positive locking.

In particular, the first sub-element of the coupling element and/or the second sub-element of the coupling element can be configured to interact in order to lock the two sub-elements in the end position of pivoting when the sub-elements are pivoted.

For this purpose, the first sub-element and the second sub-element can be configured by means of a latching connection to lock the two sub-elements in the end position of pivoting.

According to one aspect, the first sub-element can have a latching hook of the latching connection and the second sub-element can have a notch of the latching connection corresponding to a shape of the latching hook in order to lock the first sub-element and the second sub-element by means of the latching connection.

Advantageously, the tongue of the first sub-element and the recess of the second sub-element can be arranged and/or configured to interact in order to act like a rotation axis for the pivoting of the first sub-element with the second sub-element, so that when the first sub-element is pivoted against the second sub-element, the end face of the first edge-side projection and the end face of the second edge-side projection are arranged directly adjacent to one another on the front-side outer surface of the components.

In this case, a center point of said rotation axis can lie outside the connecting element and pivoting of the sub-elements with respect to said rotation axis can cause a joint or a gap between the end face of the first edge-side projection and the end face of the second edge-side projection to be reduced, so that the joint is closed in the end position of pivoting.

In particular, the latching hook of the first sub-element and the notch of the second sub-element can be configured to form an elastically coupled latching connection based on an interaction of the curved tongue of the first sub-element and the curved recess of the second sub-element. For this purpose, an engagement surface on a top surface of the curved tongue can act elastically on a top surface of the recess by deforming the curved tongue in order to insert the latching hook sufficiently deep into the recess and to lock it by means of the elastic effect.

Advantageously, the second sub-element can have a cavity on a side, opposite the notch, of a receiving space for the latching hook in the second sub-element in order to couple the latching connection non-releasably, in particular non-releasably without destruction, in a latched position of the latching connection by means of a cured adhesive that fills the cavity.

According to one aspect, the first sub-element and/or the second sub-element can be configured to fix the two sub-elements in the end position of pivoting by means of an adhesive bond between the first sub-element and the second sub-element.

According to one aspect, it is proposed for the first sub-element to have a positioning stop and for the second sub-element to have a corresponding positioning receptacle in order to form a positioning device for pivoting when joining the first sub-element and the second sub-element.

A connecting system for mechanically coupling components comprising a first component, a second component, a first sub-element and a second sub-element is proposed, wherein in particular the first sub-element and the second sub-element have been described above. The first component has a first edge-side projection and the second component has a second edge-side projection. The first sub-element, as described above, has a first tab and can be designed according to a first profile strip. The second sub-element, as described above, has a second tab and can be designed according to a second profile strip. The first sub-element is configured to be mechanically coupled to the first component and the second sub-element is configured to be mechanically coupled to the second component. So that, by coupling the first sub-element to the second sub-element by bringing them together and/or pivoting them, the first component is coupled to the second component, wherein the end face of the first edge-side projection and the end face of the second edge-side projection are arranged adjacent to one another on a front-side outer surface of the edge-side projections.

The use of a connecting element as described above for coupling layered composite panels is proposed.

### BRIEF DESCRIPTION OF THE DRAWINGS

The invention has been explained by way of example in the present description. It can be modified in many ways. Also, different elements or features of the individual embodiments can be combined with one another.

In the figures:

FIG. 1 shows a schematic representation of a connecting element;

FIG. 2 shows a schematic representation of a further connecting element;

FIG. 3 shows a schematic representation of a first sub-element of the further connecting element; and

FIG. 4 shows a schematic representation of a second sub-element of the further connecting element.

### DETAILED DESCRIPTION

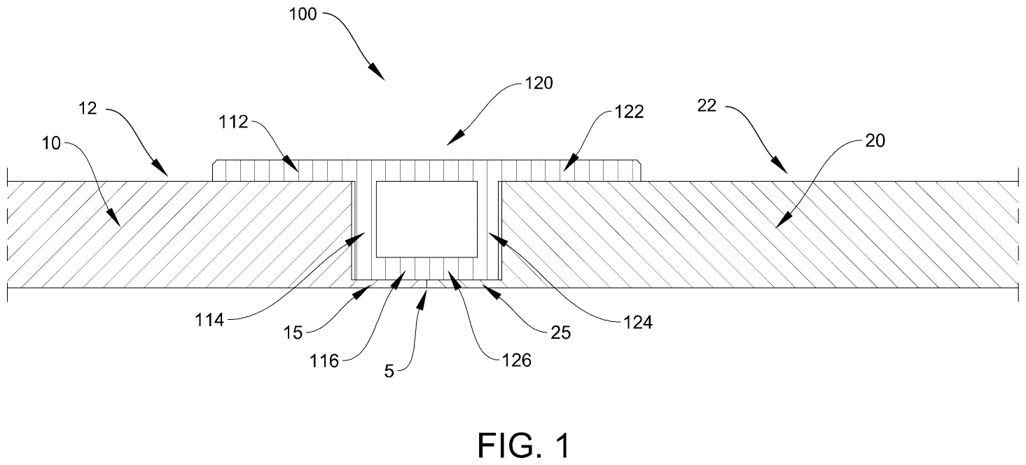

FIG. 1 schematically outlines a connecting element 100 for mechanically coupling components 10, 20, such as layered composite panels, to a first tab 112 and a second tab 122 and a coupling element 120. The first tab is configured to mechanically couple a rear outer surface 12 of the first component 10 to the connecting element 100. The second tab 122 is configured to mechanically couple a rear outer surface 22 of the second component 20 to the connecting element 100. The coupling element 120 is mechanically coupled to the first tab 112 and the second tab 122. The first component 10 and the second component 20 each have an edge-side projection 15, 25. The coupling element 120 is configured to mechanically couple the first edge-side projection 15 of the first component and the second edge-side projection 25 of the second component to the coupling element 120 such that an end face 5 of the first edge-side projection 15 and an end face 5 of the second edge-side projection 25 are arranged adjacent to one another, in particular directly, on a front-side outer surface of the edge-side projections 15, 25.

The first tab 112 and the second tab 122 can be mechanically coupled to the particular rear outer surfaces 12, 22 by means of a screw and/or an adhesive connection. The front-side outer surface of the particular edge-side projection 15, 25 of the particular component 10, 20 can continue a front-side outer surface of the particular component by means of the connecting element, so that in particular the front-side outer surfaces of the components and the front-side outer surfaces of the edge-side projections 15, 25 are aligned flush with one another.

The end faces of the edge-side projections 15, 25 can be inclined at right angles to the front-side outer surface or at an angle to the front-side outer surface of the edge-side projections. The front side of the first planar component 10 and of the second planar component 20 can be arranged linearly adjacent to one another, so that at least at some points the end faces of the edge-side projections are in contact with one another.

The connecting element 100 can be designed in the form of an elongated profile strip in order to mechanically couple an extending edge of the first component 10 and an extending edge of the second component 20 to one another.

In particular, the coupling element 120 can have a contact surface 116, 126 and can be configured to mechanically couple an inwardly directed surface of the first edge-side projection 15 of the first component and an inwardly directed surface of the second lateral projection 25 of the second component to the contact surface 116, 126 of the coupling element 120 by means of the contact surface 116, 126 in order to arrange the end face 5 of the first edge-side projection and the end face 5 of the second edge-side projection adjacent to one another on a front-side outer surface of the edge-side projections 15, 25.

Coupling of the particular inwardly directed surfaces of the lateral projections 15, 25 can be effected by bonding, in particular surface bonding, the inwardly directed surfaces of the particular edge-side projections 15, 25 to at least part of the contact surface 116, 126 by means of an adhesive and/or by means of an adhesive tape. The coupling element 120 can be configured to be arranged at least predominantly between the first component 10 and the second component 20. The first component 10 and/or the second component 20 can each comprise a layered composite panel, wherein the first edge-side projection 15 and/or the second edge-side projection 25 is substantially formed by a corresponding top layer of the particular layered composite panel. The coupling element 120 can be configured to be mechanically coupled to a side surface of the first component 10 by means of a first side surface 114 and/or to be mechanically coupled to a side surface of the second component 20 by means of a second side surface 124 of the coupling element.

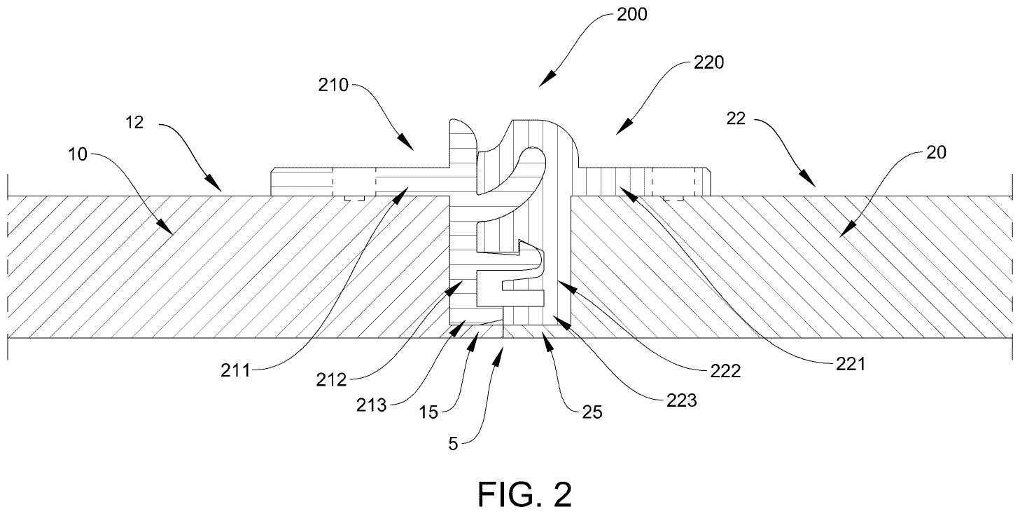

FIG. 2 schematically outlines a connecting element 200 for mechanically coupling components 10, 20, such as layered composite panels, with a first tab 211 and a second tab 221, wherein the connecting element is formed in two parts and the coupling element and/or the connecting element has a first sub-element 210 and a second sub-element 220. Thus, the first sub-element 210 of the coupling element 200 with the first tab 211 can form a first part of the connecting element and the second sub-element 22 of the coupling element 200 with the second tab 221 can form a second part of the connecting element 200.

The first tab 211 is configured to mechanically couple a rear outer surface 12 of the first component 10 to the connecting element 200. The second tab 221 is configured to mechanically couple a rear outer surface 22 of the second component 20 to the connecting element 100.

The first sub-element 210 of the coupling element is mechanically coupled to the first tab 211 and the second sub-element 220 is mechanically coupled to the second tab 221. The first component 10 and the second component 20 each have an edge-side projection 15, 25.

The first sub-element 210 of the coupling element can be configured with a contact surface 213 to mechanically couple the first edge-side projection 15 of the first component to the first sub-element 210; and the second sub-element 220 can be configured with the contact surface 223 to mechanically couple the second edge-side projection 25 of the second component to the second sub-element 220 such that an end face 5 of the first edge-side projection 15 and an end face 5 of the second edge-side projection 25 are arranged adjacent to one another, in particular directly, on a front-side outer surface of the edge-side projections 15, 25.

The first tab 211 and the second tab 221 can be mechanically coupled to the respective rear outer surfaces 12, 22 by means of a screw and/or an adhesive connection. The front-side outer surface of the particular edge-side projection 15, 25 of the particular component 10, 20 can continue a front-side outer surface of the particular component by means of the connecting element, so that in particular the front-side outer surfaces of the components and the front-side outer surfaces of the edge-side projections 15, 25 are aligned flush with one another.

The end faces of the edge-side projections 15, 25 can be inclined at right angles to the front-side outer surface or at an angle to the front-side outer surface of the edge-side projections. The front side of the first planar component 10 and of the second planar component 20 can be arranged linearly adjacent to one another, so that at least at some points the end faces of the edge-side projections are in contact with one another.

The connecting element 200 can be designed in the form of an elongated profile strip in order to mechanically couple an extending edge of the first component 10 and an extending edge of the second component 20 to one another.

In particular, the first sub-element 210 can have a contact surface 213 and can be configured to mechanically couple the inwardly directed surface of the first edge-side projection 15 of the first component to the contact surface 213 of the first sub-element 210 by means of the contact surface 213. The sub-element 220 can have a contact surface 223 to mechanically couple the inwardly directed surface of the second lateral projection 25 of the second component to the contact surface 223, so that the end face of the first edge-side projection and the end face of the second edge-side projection can be arranged adjacent to one another on a front-side outer surface 5 of the edge-side projections 15, 25.

Coupling of the respective inwardly directed surfaces of the lateral projections 15, 25 can be effected by bonding, in particular surface bonding, the inwardly directed surfaces of the respective edge-side projections 15, 25 to at least part of the contact surfaces 213, 223 by means of an adhesive and/or by means of an adhesive tape. The first sub-element 210 and the second sub-element 220 can be configured to be arranged at least predominantly between the first component 10 and the second component 20. The first component 10 and/or the second component 20 can each comprise a layered composite panel, wherein the first edge-side projection 15 and/or the second edge-side projection 25 is substantially formed by a corresponding top layer of the particular layered composite panel. The first sub-element 210 can be configured to be mechanically coupled to a side surface of the first component 10 by means of a first side surface 212. Alternatively or additionally, the second sub-element 220 can be configured to be mechanically coupled to a side surface of the second component 20 by means of a second side surface 222.

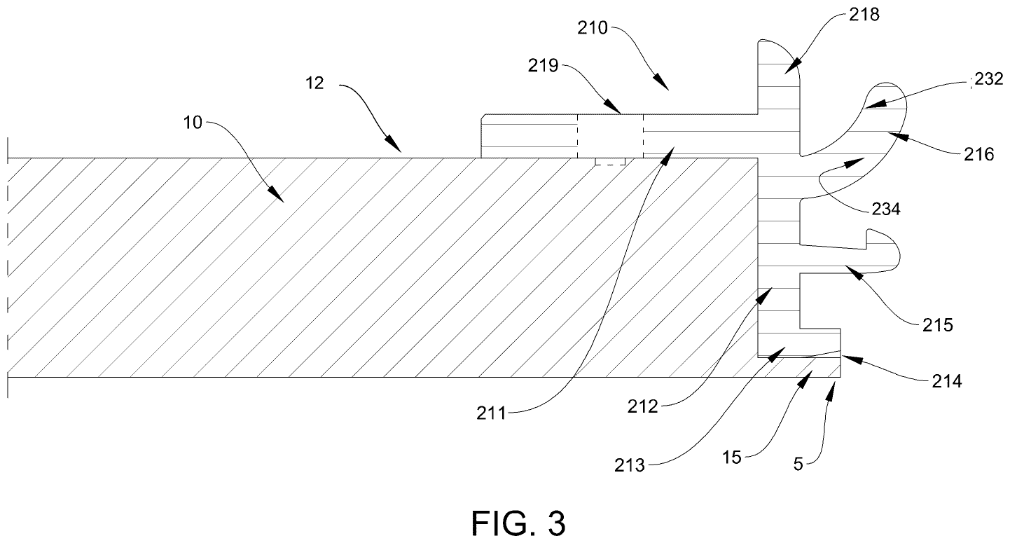

FIG. 3 schematically outlines the first sub-element 210 of the two-part connecting element 200, the mechanical coupling of which with the first component 10 was described in FIG. 2. The first sub-element 210 has the first tab 211, which is configured to mechanically couple a rear outer surface 12 of the first component 10 to the connecting element 200 or to the first sub-element 210, as described for FIG. 2. The first tab 211 can be mechanically coupled, for example by means of a screw which is guided through an opening 219 of the first tab 211, with the first component 10 to the first sub-element 210.

By means of the contact surface 213 of the first sub-element 210, the inwardly directed surface of the first edge-side projection 15 of the first component 10 can be coupled mechanically, for example by means of an adhesive connection. An end face 214 of the contact surface 213 can be set back so far from the end face 5 of the first lateral projection 15 that the end position of pivoting the sub-elements on the side of the first sub-element 210 is defined by the end face 5 of the first lateral projection.

The first sub-element 210 can have a tongue 216 which is curved in a cross section and which is configured to interact with a recess of the second sub-element which is curved in a cross section in order to form a mutual positive connection of the respective sub-elements when the first sub-element 210 is brought together with and pivoted relative to the second sub-element 220 in an end position of pivoting.

In particular, the shape of the curved tongue 216 and the curved recess 226 can be configured to effect a mutual positive locking of the respective sub-elements in a direction parallel to the front-side outer surface of the components. For this purpose, the curved tongue can form a concave, in particular circular cylinder segment-shaped, engagement surface 232 on a top surface of the tongue 216. In addition, the curved recess 226 can form a convex, in particular circular cylinder segment-shaped, engagement surface 227 on a top surface of the recess 226 for the mutual positive locking, wherein the engagement surfaces can be arranged adjacent to one another in the end position of pivoting in order to effect the mutual positive locking.

The first sub-element 210 can be configured to interact with the second sub-element 220 by means of a latching connection 215, 226 in order to lock the two sub-elements 210, 220 in the end position of pivoting when the sub-elements 210, 220 are pivoted. For this purpose, the first sub-element 210 can have a latching hook 215 of the latching connection, which is configured to interact with a notch of the latching connection of the second sub-element 220 corresponding to a shape of the latching hook in order to lock the first sub-element 210 and the second sub-element 220 by means of the latching connection.

The first sub-element can have a positioning stop 218 which is configured to interact with a corresponding positioning receptacle 228 of the second sub-element 220 in order to form a positioning device for the subsequent pivoting when joining the first sub-element 210 to the second sub-element 220.

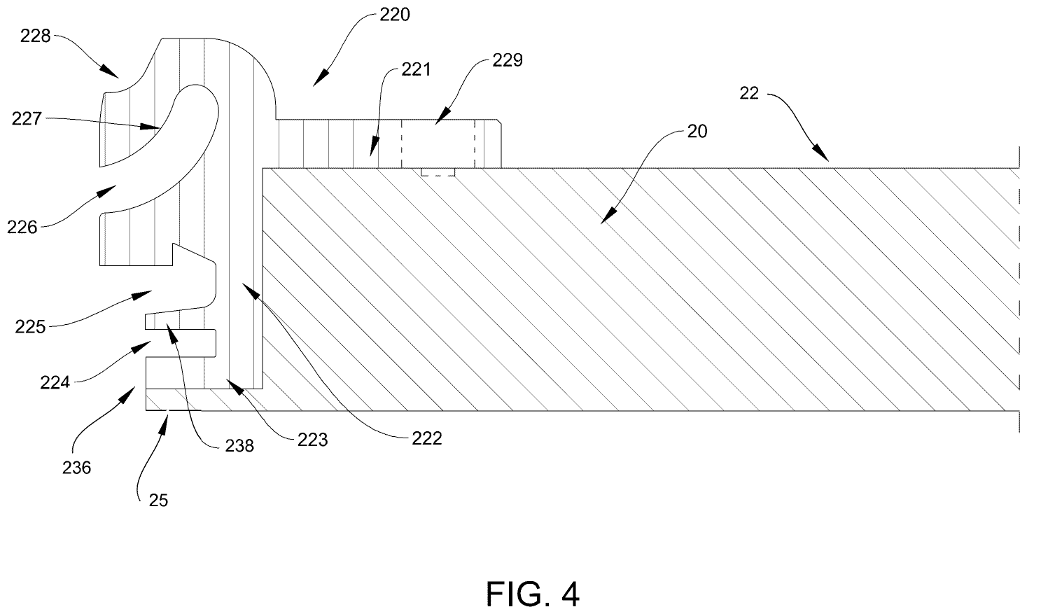

FIG. 4 schematically outlines the second sub-element 220 of the two-part connecting element 200, the mechanical coupling of which with the second component 10 was described in FIG. 2. The second sub-element 220 has the second tab 221, which is configured to mechanically couple a rear outer surface 12 of the second component 20 to the connecting element 200 or to the second sub-element 220, as described for FIG. 2. The second tab 221 can be mechanically coupled, for example by means of a screw which is guided through an opening 229 of the second tab 221, with the second component 10.

By means of the contact surface 223 of the second sub-element 220, the inwardly directed surface of the second edge-side projection 25 of the second component 20 can be coupled mechanically, for example by means of an adhesive connection. A face side 236 of the contact surface 223 can be set back so far from the end face 5 of the second lateral projection 25 that the end position of pivoting the sub-elements on the side of the second sub-element 220 is defined by the end face 5 of the second lateral projection.

The second sub-element 210 can have a recess 226 which is curved in a cross section and which is configured to interact with a tongue 216 of the first sub-element which is curved in a cross section in order to form a mutual positive connection of the respective sub-elements when the first sub-element 210 is brought together with and pivoted relative to the second sub-element 220 in an end position of pivoting.

The second sub-element 220 can be configured to interact with the first sub-element 210 by means of a latching connection 215, 226 in order to lock the two sub-elements 210, 220 in the end position of pivoting when the sub-elements 210, 220 are pivoted. For this purpose, the second sub-element 210 can have a notch 255 of the latching connection, which is configured to interact with a shape of the latching hook of the latching connection of the first sub-element 210 corresponding to a shape of the notch, in order to lock the first sub-element 210 and the second sub-element 220 by means of the latching connection.

The second sub-element can have a positioning receptacle 228 which is configured to interact with a correspondingly shaped positioning stop 218 of the first sub-element 220 in order to form a positioning device for the subsequent pivoting when joining the first sub-element 210 and the second sub-element 220.

The second sub-element 220 can have a cavity 224 on a side of the receiving space for the latching hook 215 opposite the notch in order to non-releasably lock the latching connection in a latched position of the latching connection by means of a cured adhesive that fills the cavity 224.

The second sub-element 220 can have a web 238 which guides the latching hook 215 into the notch 225 for locking the latching connection.

The curved tongue 216 of the first sub-element 210 and the curved recess 226 of the second sub-element 220 can be configured, in particular through their shaping of the curvature, to interact in order to act like a rotation axis for the pivoting of the first sub-element 210 with the second sub-element 220, so that when the first sub-element 210 is pivoted against the second sub-element 220, the end face 5 of the first edge-side projection 15 and the end face 5 of the second edge-side projection 25 are arranged directly adjacent to one another on the front-side outer surface of the components 10, 20. In this case, a shape of the curved recess 226 corresponds to a shape of the curved tongue 216 in order to receive the curved tongue 216 in the curved recess by means of pivoting. The shape of the curved tongue can correspond to the shape of the recess in such a way that in the end position of pivoting a positive connection of at least one top surface of the tongue with at least one top surface of the recess results.

The latching hook 215 of the first sub-element 210 and the notch 225 of the second sub-element 22 can be configured to form an elastically coupled latching connection based on an interaction of the curved tongue 260 of the first sub-element by means of the engagement surface 234 acting on an engagement surface of the curved recess of the second sub-element.

1. A connecting element for mechanically coupling components, comprising:
a first tab configured to mechanically couple a rear outer surface of a first component to the connecting element;
a second tab which is configured to mechanically couple a rear outer surface of a second component to the connecting element; and
a coupling element which is mechanically coupled to the first tab and the second tab; and
wherein the first component having a first edge-side projection and the second component having a second edge-side projection; and
wherein the coupling element is configured to mechanically couple the first edge-side projection of the first component and the second edge-side projection of the second component to the coupling element such that an end face of the first edge-side projection and an end face of the second edge-side projection are arranged adjacent to one another on a front-side outer surface of the first edge-side projections and the second edge-side projection.

2. The connecting element according to claim 1, wherein the coupling element has a contact surface; and the coupling element is configured to mechanically couple an inwardly directed surface of the first edge-side projection of the first component and an inwardly directed surface of the second edge-side projection of the second component to the contact surface of the coupling element by means of the contact surface in order to arrange the end face of the first edge-side projection and the end face of the second edge-side projection adjacent to one another.

3. The connecting element according to claim 1, wherein the coupling element is configured to be arranged at least predominantly between the first component and the second component; and/or is configured to be mechanically coupled to a side surface of the first component by means of a first side surface of the coupling element; and/or is configured to be mechanically coupled to a side surface of the second component by means of a second side surface of the coupling element.

4. The connecting element according to claim 1, wherein the first component and/or the second component each comprise a layered composite panel; and the first edge-side projection and/or the second edge-side projection is substantially formed by a corresponding top layer of the particular layered composite panel.

5. The connecting element according to claim 1, wherein the connecting element is formed in two parts, and the coupling element has a first sub-element with the first tab and a second sub-element with the second tab; wherein, when the first sub-element and the second sub-element are brought together and pivoted, the first sub-element and the second sub-element are designed to interact such that the end position of pivoting is defined by the end face of the first edge-side projection and the end face of the second edge-side projection abutting against one another.

6. The connecting element according to claim 5, wherein the first sub-element has a tongue which is curved in a cross section; and wherein the second sub-element has a recess which is curved in a cross section; and the first sub-element and the second sub-element are designed such that, by pivoting the first sub-element relative to the second sub-element in an end position of pivoting, a mutual positive connection of the respective first sub-element and the second sub-element of the coupling element is formed.

7. The connecting element according to claim 5, wherein the first sub-element of the coupling element and/or the second sub-element of the coupling element are configured to interact in order to lock the first sub-element and the second sub-element in the end position of pivoting when the first sub-element and the second sub-element are pivoted.

8. The connecting element according to claim 7, wherein the first sub-element and the second sub-element are configured by means of a latching connection to lock the first sub-element and the second sub-element in the end position of pivoting.

9. The connecting element according to claim 8, wherein the first sub-element has a latching hook of the latching connection; and the second sub-element has a notch of the latching connection corresponding to a shape of the latching hook in order to lock the first sub-element and the second sub-element by means of the latching connection.

10. The connecting element according to claim 9, wherein the tongue of the first sub-element and the recess of the second sub-element are configured to interact in order to act like a rotation axis for the pivoting of the first sub-element with the second sub-element, so that when the first sub-element is pivoted against the second sub-element, the end face of the first edge-side projection and the end face of the second edge-side projection are arranged directly adjacent to one another on the front-side outer surface of the components.

11. The connecting element according to claim 9, wherein the latching hook of the first sub-element and the notch of the second sub-element are configured to form an elastically coupled latching connection based on an interaction of the tongue of the first sub-element and the recess of the second sub-element.

12. The connecting element according to claim 11, wherein the second sub-element has a cavity on a side of a receiving space for the latching hook in the second sub-element opposite the notch in order to non-releasably couple the latching connection in a latched position of the latching connection by means of a cured adhesive that fills the cavity.

13. The connecting element according to claim 5, wherein the first sub-element has a positioning stop and the second sub-element has a corresponding positioning receptacle in order to form a positioning device for pivoting when joining the first sub-element and the second sub-element.

14. A connecting system for mechanically coupling components, comprising:
a first component with a first edge-side projection; and a second component with a second edge-side projection;
a first sub-element with a first tab, which is designed according to a first profile strip; and
a second sub-element with a second tab, which is designed according to a second profile strip, wherein the first sub-element is configured to be mechanically coupled to the first component; and wherein the second sub-element is configured to be mechanically coupled to the second component.

15. A use of a connecting element according to claim 1 for coupling layered composite panels or sandwich panels.
